(19) United States
(12) Patent Application Publication
(10) Pub. No.: US 2026/0348487 A1
(43) Pub. Date: Nov. 5, 2026

(54) DUAL-ACTIVATION LIQUID VALVE

(71) Applicant: STRAUSS WATER LTD, Or Yehuda (IL)

(72) Inventor: Raviv TARANTO, Rishon Lezion (IL)

(21) Appl. No.: 19/486,436

(22) PCT Filed: May 22, 2024
(86) PCT No.: PCT/IL2024/050500

§ 371 Date: Nov. 21, 2025

Related U.S. Application Data
(60) Provisional application No. 63/468,396, filed on May 23, 2023.

(51) Int. Cl. F16K 31/06; F16K 31/44

(52) U.S. Cl. CPC F16K 31/0655; F16K 31/44

(57) ABSTRACT

The present disclosure concerns valves, more specifically valves for liquid delivery through a liquid flow line, for example dispensing of drinking water. The valves having a dual operation mode, namely an electrical operation mode and a mechanical operation mode, such that the valve can be mechanically operated upon shortage of electricity.

### TECHNOLOGICAL FIELD

The present disclosure concerns valves, more specifically valves for liquid delivery through a liquid flow line.

### BACKGROUND

Various valve units for controlling flow of liquid, e.g. water, through a flow line are known. Typically, such valves are operated in one, single mode—either mechanically, e.g. by direct actuation of the user, or electrically.

In some systems, in which safety operation is required in the case of power shortage, or in cases where electrical systems are less stable, dual valve units may be used, for example in agricultural applications, such as watering or fertilization. However, up to date, such valves have been based on rotational mechanisms, which are typically complicated to produce and assemble. Such rotationally based valves are also susceptible to mechanical failure due to corrosion or erosion of the threading mechanism, or accumulation of impurities at the threading.

### GENERAL DESCRIPTION

The present disclosure concerns dual valves that can be operated both electrically and mechanically, and are based on linear movement. Hence, the valves of this disclosure can be easily operated during electrical failure or shortage, as well as require relatively small linear displacement compared to common rotational valves, that typically need a significantly larger extent of manipulation in order to mechanically activate the valve (typically rotation of 90 degrees or more). The valves of this disclosure may also be simpler to produce and less susceptible to mechanical failure.

According to one of its aspects, the present disclosure provides a valve suitable for fitting on a liquid flow line to selectively permit flow of liquid through said flow line, the valve comprises a valve housing that has a longitudinal axis and defines a central longitudinal bore, and a piston arrangement fitted within the longitudinal bore. The piston arrangement comprises a first piston and a second piston, coupled to one another by a coupling arrangement. The first piston has a first end portion that is fitted with a sealing member, and a second, opposite end portion; the first piston is electrically-driven to linearly displace within the bore between a first sealing position, in which the sealing member engages a liquid inlet of a flow line to prevent flow of liquid through said inlet, and a first open position in which the sealing member is displaced from said inlet to permit flow of liquid into the flow line. The second piston is coupled to the first piston at said second end portion by said coupling arrangement; the second piston is mechanically-operated to linearly displace within the bore between a second sealing position, corresponding to said first sealing position, and a second open position, in which said coupling arrangement mechanically displaces said first piston into said first open position. The coupling arrangement is configured to permit displacement of the first piston without substantive displacement of the second piston when the valve is operated in an electrically-driven mode, and permit mutual linear displacement of the first and second pistons driven by said second piston when the valve is operated in a mechanically-operated mode.

In other words, the valve of this disclosure provides a combined operation mechanism, which is based on linear movement, that allows operating the valve in both electrical-mode and mechanical-mode. This dual operation is permitted by an arrangement of coupled pistons, a first of the pistons being an electrically-driven piston and a second of the pistons being a mechanically-operated piston. The coupling arrangement permits operation of the electrically-driven piston without substantive displacement of the mechanically-operated piston when the valve is operated in the electrical-mode; when the valve is operated in the mechanical-mode, the mechanically-operated displacement of the second piston causes induced mechanical displacement of the first piston due to the coupling arrangement disposed between the pistons.

In this manner, the valve can be securely and reliably operated even in the absence of electricity or in times when electrical operation is undesired.

According to some embodiments, the second piston is biased to the second sealing position by a biasing member.

According to some embodiments, the second piston has a terminal end portion, opposite said coupling end portion, the terminal end portion being coupled to, or mechanically associated with, a mechanical actuation member. The mechanical actuation member is typically user-accessible, such that operation of the mechanical actuation member causes the displacement of the second piston between the second sealing position and the second open position.

The second end portion of the first piston, by some embodiments, comprises a cavity that accommodates a coupling end portion of the second piston. In some embodiments, the coupling arrangement comprises a coupling bore defined in the coupling end portion of the second piston and extends in the coupling end portion substantially perpendicular to the longitudinal axis of the valve housing, and a coupling pin that can be received through the coupling bore and through corresponding pin-receiving openings in the second end portion of the first piston.

By an embodiment, a dimension of the coupling bore along the longitudinal axis is larger than a dimension of said coupling pin along the longitudinal axis. For example, when the bore and the pin have round cross sections, then the diameter of the coupling bore is larger than the diameter of the coupling pin, such that, when the bore and the pin are concentric, the pin does not contact the walls of the bore.

In other words, according to such embodiments, the difference in corresponding dimensions along the longitudinal axis of the coupling pin and the coupling bore results in a degree of freedom in the coupling arrangement along the longitudinal direction. Such degree of freedom permits the first, electrically-driven piston, to be displaced from the first sealing position to the first open position without substantial displacement of the second piston, as in such movement the coupling pin does not substantially engage the walls of the coupling bore along the longitudinal direction. When the valve is operated in the mechanical mode, the displacement of the second, mechanically-operated piston from the second sealing position to the second open position will cause engagement of the walls of the coupling bore with the coupling pin, thereby transmitting the mechanical movement from the second piston to the first piston to induce mechanical corresponding displacement of the first piston into the first open position.

The first piston can be operated in any suitable electrically-operating arrangement. According to some embodiments, the valve comprises a solenoid for electrically driving the first piston between the first sealing position and the first open position.

According to some embodiments, the solenoid causes reciprocal displacement of the first piston between the first sealing position and the first open position upon user command.

According to other embodiments, the first piston is biased to the first sealing position by a biasing element, i.e. causing the first piston to assume a “normally closed” configuration, such that once electricity feed is stopped or interrupted, the biasing element returns the first piston into its first sealing position.

The valve may be incorporated into variety of liquid flow lines, either gravitational flow lines or pressure-fed flow lines. Typically, when the valve is incorporated into a pressure-fed flow line, it is desirable to provide a mechanism by which the pressure of liquid will not cause unintentional mechanical operation of the valve.

Hence, according to some embodiments, the first end portion of the first piston comprises a pressure-equilibration cavity. This pressure-equilibrium cavity is located in the first end portion of the first piston, typically above the sealing member (i.e. vertically displaced from the sealing member along the longitudinal axis) and is designed to be filled with liquid from the flow line. Once liquid is fed under pressure into the flow line, the liquid in the pressure-equilibration cavity will exert pressure towards the sealing member, assisting in maintaining a sealing engagement between the sealing member and the liquid inlet of the liquid flow line.

By another aspect, this disclosure provides a valve assembly for fitting into a liquid flow line, the valve assembly comprises a valve assembly inlet and a valve assembly outlet, the valve assembly inlet and valve assembly outlet are configured for connecting to said liquid flow line; and a valve as described herein, fitted between the valve assembly inlet and valve assembly outlet, such that when in the first or second sealing positions, said sealing member prevents liquid flow between the valve assembly inlet and valve assembly outlet.

According to some embodiments, the valve comprises a filtering unit positioned between the valve assembly inlet and the valve. According to other embodiments, the valve comprises a filtering unit positioned between the valve and the valve assembly outlet. The filtering unit is typically designed to filter-out particulate impurities from the liquid. For example, when the liquid is water, the filter functions to filter-out particles of substances that are undesired for consumption. The filter unit can also function, according to other examples, to add various desired ingredients to the liquid; in the case of drinking water, for example, such ingredients can be taste enhancers, taste masking agents, nutritional additives, flavoring compounds, etc.

According to yet another aspect, this disclosure provides a tap for permitting selective dispensing of liquid, the tap comprising: a connecting arrangement, configured to connect to a terminus of a liquid flow line; a liquid dispensing nozzle; and a valve as disclosed herein that is fitted between said connecting arrangement and said dispensing nozzle, such that when in the first or second sealing positions, said sealing member prevents liquid flow from the flow line to the dispensing nozzle.

In other words, the valve can be integrated within a tap or faucet unit that is designed to be fitted at a terminus of the liquid flow line, to permit selective dispensing of the liquid from the flow line by user-operation of the tap.

According to some embodiments, the connecting arrangement, the liquid dispensing nozzle and the housing of valve are integrally formed one with the other.

According to some other embodiments, the connecting arrangement, the liquid dispensing nozzle and the housing of valve are integratable with one another.

The valve included in the tap permits selective dispensing of the liquid in both the electrically-driven mode and the mechanically-operated mode, as described above. In some embodiments, the tap comprises a mechanical actuation member coupled to the second piston, thereby permitting operation of the valve in a mechanically-operated mode by a user.

According to some embodiments, the tap comprises a filtering unit positioned between the connecting arrangement and the valve. According to some other embodiments, the tap comprises a filtering unit positioned between the valve and the dispensing nozzle.

By another aspect, the present disclosure provides a tap kit configured for installation at a terminus of a liquid flow line, the kit comprises: a connecting arrangement, configured to connect to said terminus; a liquid dispensing nozzle; and a valve as disclosed herein that is configured for fitting between said connecting arrangement and said dispensing nozzle, such that when in the first or second sealing positions, said sealing member prevents liquid flow from the flow line to the dispensing nozzle.

By yet another aspect, there is provided a liquid dispenser comprising the valve disclosed herein.

By some embodiments, the liquid dispenser is configured for operation in both an electrical mode and mechanical mode.

By some other embodiments, the liquid dispenser is configured for selective operation of the valve in an electrical or mechanical mode.

By yet other embodiments, the liquid dispenser is configured to prevent electrical operation of the valve at pre-determined times. Such pre-determined times can be, for example, during observation of religious holy-days (e.g. the Jewish Sabbath), in which utilization of electricity is not permitted; during times of electrical shortage; when utilized in devices which are located in areas having intermittent electricity supply; due to reduction in electrical consumption considerations; etc.

By some embodiments, the liquid dispenser comprises at least one electrical actuator to permit actuation of the first, electrically-driven, piston of the valve, to permit liquid dispensing upon user demand; and at least one mechanical actuator, associated with or mechanically linked to the second, mechanically-operated, piston of the valve, to permit liquid dispensing upon user demand when the valve is in its mechanically-operated mode.

According to some embodiments, the liquid dispenser comprises at least one controller, for selectively controlling the supply of electricity to the valve.

According to other embodiments, the liquid dispenser comprises at least one shut-off mechanism, associated with the valve, to permit a user to selectively shut-off the electrical-mode operation of the valve upon user demand.

According to some embodiments, the liquid dispenser is a water dispenser.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a side-view of a valve of a valve assembly according to an embodiment of this disclosure.

FIG. 2A is a longitudinal cross section of the valve of FIG. 1, in the first/second sealing positions.

FIG. 2B is a close-up view of detail II in FIG. 2A, showing the coupling mechanism.

FIG. 3A is a longitudinal cross section of the valve of FIG. 1, in the first open position.

FIG. 3B is a longitudinal cross section of the valve of FIG. 1, in the second open position.

### DETAILED DESCRIPTION OF EMBODIMENTS

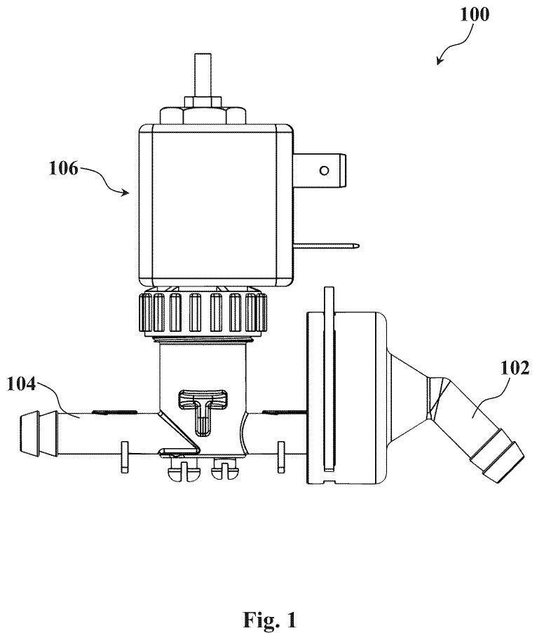

Turning to FIG. 1, shown is a valve assembly 100, that comprises a valve assembly inlet 102 and a valve assembly outlet 104 that define between them a liquid flow line. The valve assembly inlet and valve assembly outlet are typically configured for connecting to a liquid flow line, for example, a pressurized water flow line. A valve 106 is fitted between the valve assembly inlet 102 and valve assembly outlet 104, such that operation of the valve permits selective flow of liquid from the inlet to the outlet.

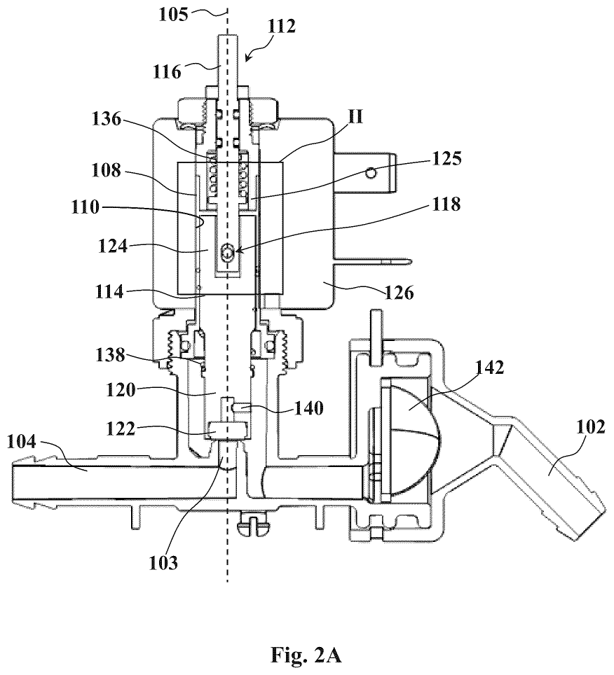

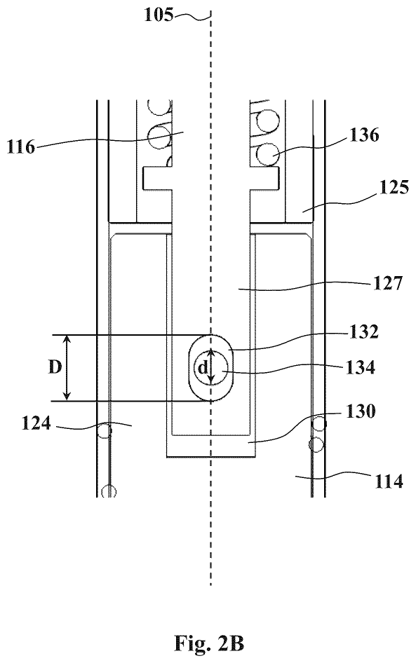

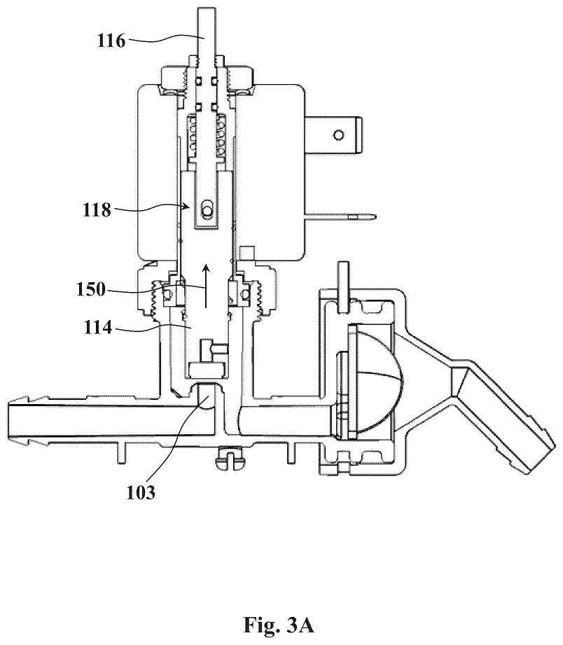

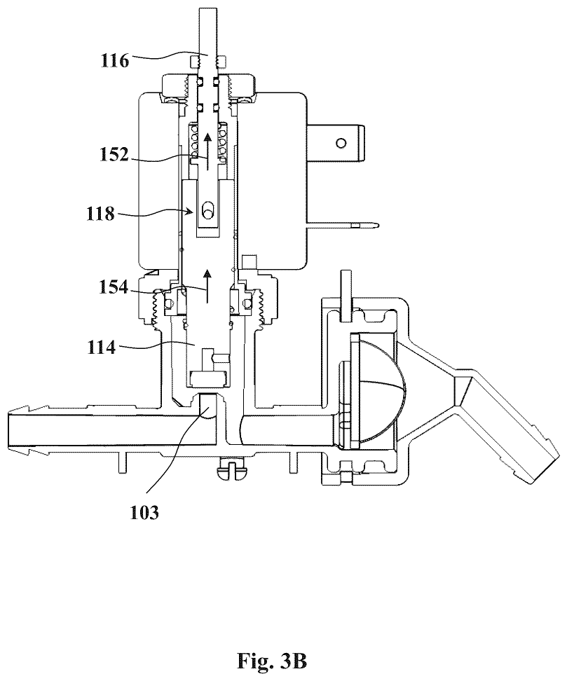

Valve 106, as better seen in FIGS. 2A-3B, has a housing 108, defining a longitudinal axis 105 and a central longitudinal bore 110. Bore 110 accommodates a piston arrangement, generally designated 112, that permits operating the valve in both an electrical-mode and a mechanical-mode. The piston arrangement 112 comprises a first piston 114 and a second piston 116, coupled to one another by a coupling arrangement 118, as will be described below.

The first piston 114 has a first end portion 120 that is fitted with a sealing member 122, and a second, opposite end portion 124. First piston 114 has a first sealing position (FIG. 2A), in which the sealing member 122 engages a liquid inlet 103 between the valve assembly inlet 102 and valve assembly outlet 104. Thus, when the first piston is in the first sealing position, water passage from the valve assembly inlet 102 to valve assembly outlet 104 is prevented by sealing inlet 103.

The first piston is displaceable between the first sealed position (shown in FIG. 2A) to a first open position as seen in FIG. 3A, in the direction of arrow 150, to permit liquid passage from the valve assembly inlet 102 to valve assembly outlet 104, by disengaging sealing member 122 from inlet 103. The displacement between the first sealing position and the first open position is a linear displacement of first piston 114 along the longitudinal axis 105, the extent of displacement to the first open position being determined by the location of stopper element 125. In other words, when displacing to the first open position, the first piston linearly displaces along the longitudinal axis, until being stopped by engaging stopper element 125. The extent of displacement can be controlled by changing the position of the stopper element, thereby controlling the size of the gap formed between the sealing member 122 and inlet 103.

The first piston is electrically-driven, namely is electrically operated. Typically, the first piston is electrically-driven by a solenoid 126, that permits selective electrical operation of the first piston and its reciprocation between the first sealing position and the first open position, e.g. upon user demand for liquid flow through the flow line and/or dispensing of liquid from the flow line.

Second piston 116 is mechanically-operated, e.g. by mechanical actuation of a user when no electricity is supplied to the valve. Hence, the valve permits both electrical and mechanical operation modes, depending on the supply of electricity to the valve. Second piston 116 linearly displaces within bore 110 in the direction of arrow 152 between a second sealing position that corresponds to the first sealing position of the first piston (FIG. 2A), and a second open position (FIG. 3B). As noted, second piston 116 is coupled to the first piston 114 by coupling arrangement 118. Hence, transition of the second piston 116 to the second open position by mechanical operation of the second piston in the direction of arrow 152, also causes mechanical displacement of the first piston 114 due to the coupling arrangement 118 in the direction of arrow 154, as will now be described. Thus, when operating the valve in the mechanical-mode, the first and second pistons are forced to jointly displace into their open positions due to mechanical operation of the second piston.

Coupling arrangement 118 is better seen in FIG. 2B. The second end portion 124 of the first piston 114, comprises a cavity 130, that accommodates a coupling end portion 127 of the second piston 116. Formed in the coupling end portion 127 is a coupling bore 132 that extends in the coupling end portion substantially perpendicular to the longitudinal axis. A coupling pin 134 is received through the coupling bore 132 and through corresponding pin-receiving openings (not shown) in the second end portion 124 of the first piston 114. A dimension D of said coupling bore 132 along the longitudinal axis is larger than a corresponding dimension d of coupling pin 134—the difference in corresponding dimensions D and d results in a degree of freedom in the coupling arrangement 118 along the longitudinal direction. Such degree of freedom permits the first, electrically-driven piston 114, to be displaced from the first sealing position to the first open position without substantial displacement of the second piston 116 (as seen in FIG. 3A), as in such movement the coupling pin 134 does not substantially engage the walls of the coupling bore 132 along the longitudinal direction. When the valve is operated in the mechanical mode, the displacement of the second, mechanically-operated piston 116 from the second sealing position to the second open position will cause engagement of the walls of the coupling bore 132 with the coupling pin 134, thereby transmitting the mechanical movement from the second piston 116 to the first piston 114 to induce mechanical corresponding displacement of the first piston into the first open position (FIG. 3B).

Hence, the coupling mechanism 118 permits displacement of the first piston 114 without substantive displacement of the second piston 116 when the valve is operated in an electrically-driven mode, and permit mutual linear displacement of the first and second pistons 114, 116 driven by the mechanical operation of the second piston 116 when the valve is operated in a mechanically-operated mode. This results in a combined operation mechanism, which is based on linear movement, that allows operating the valve in both electrical-mode and mechanical-mode. In this manner, the valve can be securely and reliably operated even in the absence of electricity or in times when electrical operation is undesired.

The second piston 116 is typically biased to the second sealing position by a biasing member, e.g. spring 136. Hence, once a user releases a mechanical actuator, spring 136 will cause second piston 116, and due to its coupling also first piston 114, to mechanically displace back into the sealing positions.

The first piston 114 can also be biased, namely to the first sealing position, by a biasing element, for example spring 138, to cause the first piston 114 to assume a “normally closed’ configuration, such that once electricity feed is stopped or interrupted, the biasing element 138 returns the first piston 114 into its first sealing position.

As noted, the valve may be incorporated into variety of liquid flow lines, either gravitational flow lines or pressure-fed flow lines. Typically, when the valve is incorporated into a pressure-fed flow line, it is desirable to provide a mechanism by which the pressure of liquid will not cause unintentional mechanical operation of the valve. Such an exemplary mechanism is a pressure-equilibration cavity. A pressure-equilibrium cavity 140 is located, in the exemplified valve, in the first end portion 120 of the first piston 114, typically above the sealing member 122 and is designed to be filled with liquid from the flow line. Once liquid is fed under pressure into the flow line, the liquid in the pressure-equilibration cavity 140 will exert pressure towards the sealing member 122, assisting in maintaining a sealing engagement between the sealing member 122 and the liquid inlet 103.

The valve assembly can also include a filtering unit 142 positioned between the valve assembly inlet 102 and the valve 106. Alternatively, the filtering unit can be positioned between the valve and the valve assembly outlet (not shown).

As noted, the valve can be integrated into a tap assembly (or be an integral part of a tap assembly), to permit selective liquid flow through the tap, once the valve is installed onto a terminus of a liquid flow line.

The valve can also be integrated into a liquid dispenser, to permit dual operation of the valve in an electrical mode and a mechanical mode upon user demand for liquid dispensing from the liquid dispenser. Such dual operation can permit the user to selectively operate the dispenser is either the electrical mode or the mechanical mode, depending on user's need and/or limitations. For example, the liquid dispenser can be configured to prevent electrical operation of the valve at pre-determined times. Such pre-determined times can be, for example, during observation of religious holy-days (e.g. the Jewish Sabbath), in which utilization of electricity is not permitted; during times of planned electrical shortage; when utilized in devices which are located in areas having intermittent electricity supply; due to reduction in electrical consumption considerations; etc.

The liquid dispenser can include at least one electrical actuator to permit actuation of the first, electrically-driven, piston, to allow liquid dispensing upon user demand; and at least one mechanical actuator, associated with or mechanically linked to the second, mechanically-operated, piston of the valve, to permit liquid dispensing upon user demand when the valve is in its mechanically-operated mode.

The liquid dispenser can also include at least one shut-off mechanism, associated with the valve, to permit a user to selectively shut-off the electrical-mode operation of the valve upon user demand.

According to some embodiments, the liquid dispenser is a water dispenser.

1. A valve suitable for fitting on a liquid flow line to selectively permit flow of liquid through said flow line, the valve comprises:
a valve housing, having a longitudinal axis, and defining a central longitudinal bore;
a piston arrangement, fitted within the bore, and comprising:
a first piston, having a first end portion fitted with a sealing member, and a second, opposite end portion, the first piston being electrically-driven to linearly displace within the bore between a first sealing position, in which the sealing member engages a liquid inlet of a flow line to prevent flow of liquid through said inlet, and a first open position in which the sealing member is displaced from said inlet to permit flow of liquid into the flow line; and
a second piston coupled to the first piston at said second end portion by a coupling arrangement, the second piston being mechanically-operated to linearly displace within the bore between a second sealing position, corresponding to said first sealing position, and a second open position, in which said coupling arrangement mechanically displaces said first piston into said first open position,
the coupling arrangement configured to permit displacement of the first piston without substantive displacement of the second piston when the valve is operated in an electrically-driven mode, and permit mutual linear displacement of the first and second pistons driven by said second piston when the valve is operated in a mechanically-operated mode.

2. The valve of claim 1, wherein the second piston is biased to the second sealing position by a biasing member.

3. The valve of claim 1, wherein said second piston has a terminal end portion, opposite said coupling end portion, the terminal end portion being coupled to, or mechanically associated with, a mechanical actuation member.

4. The valve of claim 1, wherein said second end portion comprises a cavity, accommodating a coupling end portion of the second piston, and said coupling arrangement comprises:
a coupling bore, defined in said coupling end portion, and extending substantially perpendicular to said longitudinal axis; and
a coupling pin received through said bore and through corresponding pin-receiving openings in said second end portion.

5. The valve of claim 4, wherein a dimension of said coupling bore along the longitudinal axis is larger than a dimension of said coupling pin along the longitudinal axis.

6. The valve of claim 1, comprising a solenoid for electrically driving the first piston between the first sealing position and the first open position.

7. The valve of claim 1, wherein the first piston is biased to the first sealing position by a biasing element.

8. The valve of claim 1, wherein said first end portion comprises a pressure-equilibration cavity.

9. A valve assembly for fitting into a liquid flow line, the valve assembly comprises:
a valve assembly inlet and a valve assembly outlet, the valve assembly inlet and valve assembly outlet being configured for connecting to said liquid flow line, and
a valve according to claim 1, fitted between said valve assembly inlet and valve assembly outlet, such that when in the first or second sealing positions, said sealing member prevents liquid flow between the valve assembly inlet and valve assembly outlet.

10. The valve assembly of claim 9, comprising a filtering unit positioned between the valve assembly inlet and the valve.

11. The valve assembly of claim 9, comprising a filtering unit positioned between the valve and the valve assembly outlet.

12. A tap for permitting selective dispensing of liquid, the tap comprising:
a connecting arrangement, configured to connect to a terminus of a liquid flow line,
a liquid dispensing nozzle,
a valve according to claim 1, fitted between said connecting arrangement and said dispensing nozzle, such that when in the first or second sealing positions, said sealing member prevents liquid flow from the flow line to the dispensing nozzle.

13. The tap of claim 12, comprising a mechanical actuation member said coupled to the second piston.

14. The tap of claim 12, comprising a filtering unit positioned between the connecting arrangement and the valve.

15. The tap of claim 12, comprising a filtering unit positioned between the valve and the dispensing nozzle.

16. A liquid dispenser comprising the valve of claim 1.

17. The liquid dispenser of claim 16, configured for operation in both an electrical mode and mechanical mode.

18. The liquid dispenser of claim 16, configured for selective operation of the valve in an electrical or mechanical mode.

19. The liquid dispenser of claim 16, configured to prevent electrical operation of the valve at pre-determined times.

20. The liquid dispenser of claim 16, being a water dispenser.
